(19) United States
(12) Patent Application Publication
(10) Pub. No.: US 2022/0253265 A1
(43) Pub. Date: Aug. 11, 2022

(54) PLATFORM FOR DISTRIBUTING MEDIA CONTENT FROM ONE MOVING OBJECT TO ANOTHER

(71) Applicant: TEK AD OPUS INC., FREMONT, CA (US)

(72) Inventors: Manish Garg, Fremont, CA (US); Suhail Zain, San Ramon, CA (US)

(21) Appl. No.: 17/535,980

(22) Filed: Nov. 26, 2021

Related U.S. Application Data
(60) Provisional application No. 63/147,241, filed on Feb. 9, 2021.
(60) Provisional application No. 63/147,242, filed on Feb. 9, 2021.

(51) Int. Cl. G06F 3/14; H04W 4/021; H04W 4/02; H04W 4/44

(52) U.S. Cl. CPC G06F 3/1423; H04W 4/021; G06Q 30/0265; H04W 4/44; H04W 4/026

(57) ABSTRACT

A method and system of distributing media content includes receiving a data packet including media content from one or more content providers. A location of one or more content delivery vehicles (CDVs) is determined. For each CDV of the one or more CDVs, a content to be sent to the CDV is selected. The content is sent to the CDV to be displayed on an outward display device of the CDV upon the CDV entering a predetermined zone, in a way that is synchronous to other outward display devices of the CDVs in the predetermined zone.

### CROSS-REFERENCES TO RELATED APPLICATIONS

The present application claims the benefit of priority under 35 U.S.C. § 119 from U.S. Provisional Patent Application Ser. No. 63/147,241, filed Feb. 9, 2021 entitled “Synchronizing Display content on Multiple Advertising Vehicles within Close Proximity (Location, Speed, Density, Headway, Direction) Showing the Same Advertisement to Increase Dwell Time, and Provisional Patent Application Ser. No. 63/147,242, filed Feb. 9, 2021 entitled “Dynamic Pricing for OOH Advertising on Vehicle's Rear Windshield and Storefronts,” which are hereby incorporated by reference in its entirety for all purposes.

### BACKGROUND

### Technical Field

The present disclosure generally relates to distribution of media content, and more particularly, to distributing relevant content to be displayed from one moving object to another.

### Description of the Related Art

Content distribution is the act of promoting content to audiences in multiple media formats through various channels. Various characteristics of the consumer of this content, sometimes referred to herein as the audience, may be relevant to the transmission of targeted messages to enhance the effectiveness of content distribution campaigns created by content distribution entities. Salient characteristics in effective distribution of content include the location information of the audience, as well as time of consumption.

Providing content to moving vehicles is well recognized as a powerful content distribution tool. Several ways of such advertising are in practice today, such as placing an advertisement on a vehicle either through a wrap, painting or placing a monitor on top and having that vehicle traverse a populated route. While these advertising delivery methods do effectively display the content to a relatively large audience, the signage is mostly static and limited. For example, such content distribution can only be targeted in a very broad sense, by targeting everyone in a city or section of a city.

In recent years, the incorporation of positioning technology, such as global positioning system (GPS) technology onto mobile platforms, such as a mobile phone or GPS integrated onto a moving vehicle, has not only facilitated navigation capability, but also allowed other authorized participants to determine the location of these mobile platforms. By virtue of being aware of a location and time of travel of a mobile platform, a more focused and effective content distribution to moving vehicles can be facilitated.

### SUMMARY

According to various embodiments, a computing device, a non-transitory computer readable storage medium, and a method are provided to distribute a media content. A data packet including media content is received from one or more content providers. A location of one or more content delivery vehicles (CDVs) is determined. For each CDV of the one or more CDVs, a content to be sent to the CDV is selected. The selected content is sent to the CDV to be displayed on an outward display device of the CDV upon the CDV entering a predetermined zone, in a way that is synchronous to other outward display devices of the CDVs in the predetermined zone.

In one embodiment, the data packet includes a zone, a time of day, and a frequency of distribution of the media content.

In one embodiment, the one or more content providers include a police department, a fire department, or a municipality.

In one embodiment, a content provider of the one or more content providers is an advertiser.

In one embodiment, a direction of travel of the one or more CDVs is determined.

In one embodiment, the determination of the location of the one or more CDVs includes, for each CDV, receiving a data packet from the CDV at predetermined intervals or upon a trigger event.

In one embodiment, the data packet from the CDV includes one or more restrictions on what can be displayed on an outward display device of the CDV.

In one embodiment, one or more restrictions on what can be displayed on the CDV are received from a server.

In one embodiment, the determination of a content to be sent to the CDV includes determining whether the content violates any internal criteria of the content distribution engine; determining whether the content violates any limitation related to an account of the CDV; and removing any content that violates any internal criteria or any limitation related to the account of the CDV.

In one embodiment, the determination of a content to be sent to the CDV further includes ranking all remaining content received from the one or more content providers based on one or more predetermined criteria; and sending a content that has a highest rating to the CDV upon the CDV entering a region that includes the zone.

These and other features will become apparent from the following detailed description of illustrative embodiments thereof, which is to be read in connection with the accompanying drawings.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all the components or steps that are illustrated. When the same numeral appears in different drawings, it refers to the same or like components or steps.

FIG. 1 illustrates an example architecture 100 for an intelligent location and time aware distribution of content to users in a moving object by way of another moving object, consistent with an illustrative embodiment.

FIG. 2A illustrates an example intersection that may be a zone or subdivided into subzones, consistent with an illustrative embodiment.

FIG. 2B illustrates one side of a highway that includes a plurality of synchronized CDVs, consistent with an illustrative embodiment.

FIG. 3 provides one side of a highway that includes a plurality of CDVs in a zone, consistent with an illustrative embodiment.

FIG. 4 is a table that provides a comparison of different traffic flow rates, consistent with an illustrative embodiment.

FIG. 5 illustrates a system of two CDVs having flexible outward display devices that are synchronized to each other.

FIG. 6 provides an example camera and a monitor, consistent with an illustrative embodiment.

FIG. 7 shows example dynamic media content classification having a fair queuing system consistent with an illustrative embodiment.

FIG. 8 an example content sequencing for a display having a price point based queuing, consistent with an illustrative embodiment.

FIG. 9 illustrates a process for a computer implemented automatic media content entry, consistent with an illustrative embodiment.

FIG. 10 illustrates a simplified interaction between a computing device of a content delivery vehicle and the content distribution engine in response to content received by the content delivery vehicle, consistent with an illustrative embodiment.

FIG. 11 illustrates a process for handling conflicting requests from content providers, consistent with an example embodiment.

FIG. 12 provides an example process for an automatic distribution of media content, consistent with an illustrative embodiment.

FIG. 13 shows an example queue assignment sequence, consistent with an illustrative embodiment.

FIG. 14 shows an example queue building sequence, consistent with an illustrative embodiment.

FIG. 15 shows an example display percentage adjustment for each queue, consistent with an illustrative embodiment.

FIG. 16 shows an example of dynamic value of media content determination, consistent with an illustrative embodiment.

FIG. 17 provides a simplified process flow for distributing relevant media content to content delivery vehicles in a zone, consistent with an illustrative embodiment.

FIG. 18 illustrates a network or host computer platform, as may be used to implement the content distribution server of FIG. 1.

### DETAILED DESCRIPTION

### Overview

In the following detailed description, numerous specific details are set forth by way of examples to provide a thorough understanding of the relevant teachings. However, it should be apparent that the present teachings may be practiced without such details. In other instances, well-known methods, procedures, components, and/or circuitry have been described at a relatively high-level, without detail, to avoid unnecessarily obscuring aspects of the present teachings.

The present disclosure generally relates to systems and methods of providing media content to users in a moving object (e.g., a moving vehicle) by another moving object (e.g., another moving vehicle), while being aware of a location and time of the user, by way of a content distribution channel. To that end, media content is received from one or more content providers for a subject geographical zone. A location and a direction of content delivery vehicles (CDV) is determined. As used herein, a CDV is any vehicle, such as a car, truck, bus, motorcycle, boat, ship, helicopter, airplane, hovercraft, etc., that is subscribed to a content distribution service. A surface of the CDV, such as a rear windshield, trunk, sheet metal, etc., may be used to include a display capability (e.g., a flexible LCD) that is operative to display content to other potentially moving vehicles, collectively referred to herein as an outward display device. In some embodiments, the outward display device is attached to the vehicle as an add-on device.

In one aspect, a content to be distributed to one or more CDV is determined based on predetermined criteria (e.g., being within a region, traveling in a predetermined direction, and/or other restrictions specific to the user of the CDV, discussed in more detail later). Upon determining that a CDV meets the predetermined criteria, the relevant content to be distributed is sent to a CDV (as well as other CDVs that meet the predetermined criteria). Upon the CDV entering a zone that is within the region, the content is displayed on its outward display device in a way that is synchronous with other CDVs in that zone or subzone. The techniques described herein may be implemented in a number of ways. Example implementations are provided below with reference to the following figures.

Example Architecture

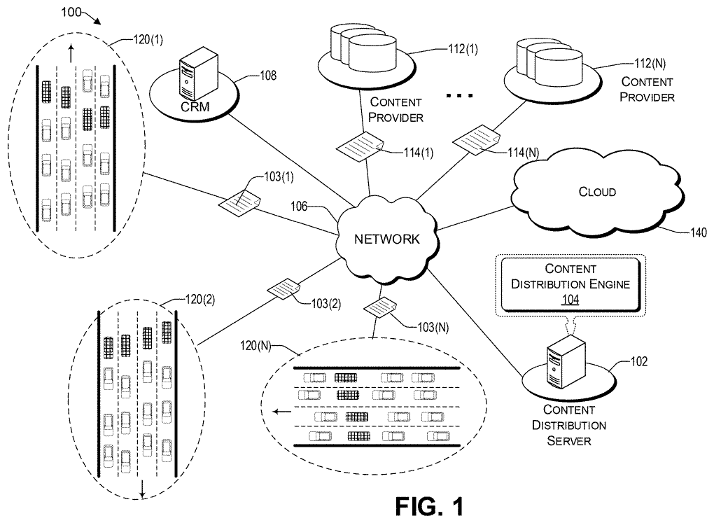

FIG. 1 illustrates an example architecture 100 for an intelligent location and time aware distribution of content to users in a moving object by way of another moving object, consistent with an illustrative embodiment. Architecture 100 includes a network 106 that allows various mobile computing devices to communicate with each other and various resources that are connected to the network 106, such as a customer relations management (CRM) server 108, one or more content providers 112(1) to 112(N), a content distribution server 102, and a cloud 140. Today, computing devices typically take the form of portable handsets, smart-phones, tablet computers, laptops, desktops, personal digital assistants (PDAs), and smart watches, although they may be implemented in other form factors, including consumer, and business electronic devices, as well as being integrated in moving vehicles.

The network 106 may be, without limitation, a local area network (“LAN”), a virtual private network (“VPN”), a cellular network, the Internet, or a combination thereof. For example, the network 106 may include a mobile network that is communicatively coupled to a private network, sometimes referred to as an intranet, that provides various ancillary services, such as communication with various application stores, libraries, CRM 108, the Internet, and the cloud 140.

The content distribution engine 104, transforms the content distribution server 102 into particularly configured computing device that is operative to receive various forms of media content 114(1) to 114(N) from various content providers 112(1) to 112(N). The content 114(1) to 114(N) may include, without limitation: text, pictures, video, audio, or any combination thereof. In various embodiments, the content providers 112(1) 112(N) may include law enforcement agency or a fire department, local municipality, etc., providing traffic guidance, warnings, and/or public service announcements (e.g., missing child alert, car stuck on the road ahead, poor weather conditions ahead, upcoming traffic delays, suggested reroute information, upcoming danger, etc.). In other scenarios, there may be highly localized advertisements, such as welcoming messages to a town (e.g., “Welcome to Orlando”), local businesses information for upcoming exit (“world renowned restaurant next exit”), or other advertisements. Content from advertisement agencies (e.g., 112(1)) related to general advertisements (e.g., 114(1)) are compatible with the architecture discussed herein.

The content distribution engine 104 is configured to prioritize the content 114(1) to 114(N) for each zone, depicted by way of example in FIG. 1 as 120(1) to 120(N). As used herein, a location relates to specific coordinates, which may be obtained, for example, by way of global position signals or cell tower triangulation from a computing device in or of a subject CDV. A region relates to a boundary at which the relevant content 103(1) to 103(N) is distributed by the content distribution engine 104 over the network 106 to the appropriate CDVs. As used herein a zone (e.g., 120(1), 120(2), or 120(N)) relates to an area where the received content (e.g., 103(1)) is displayed on an outward display of one or more CDVs (represented in FIG. 1 by vehicles with a crosshatch pattern).

For example, the content distribution engine 104 may determine a location and direction of travel of CDVs. In various embodiments, the determination of location is at predetermined intervals or upon a trigger event, such as a CDV sending its location information upon entering a region, updating its status information, or the like. In some embodiments, the frequency of the determination of location differs for different types of vehicles (e.g., truck vs. sedan). In some embodiments, CDVs having a larger outward display device may be more salient on highways, where the distances between vehicles is larger, versus high-traffic and/or gridlock situations, where a CDV may be immediately in front of the content consumer.

The content distribution engine 104 may receive a data packet from one or more CDVs over the network that may include one or more of: a present location of the CDV, a direction of the CDV, a timestamp, a status of the outward display device (e.g., whether a present content is being displayed and estimated completion time of the content), etc., collectively referred to herein as the CDV status information.

In one embodiment, the content distribution engine 104 is also configured to determine any restrictions associated with a CDV. The restrictions may include, without limitation, preferences, priorities, time constraints, geographical constraints, constraints as to a type of content (e.g., specific advertisement content), etc. In various embodiments, the restrictions may be provided as part of the data packet received from a computing device of the CDV or retrieved from a customer relations manager (CRM) server 108. For example, the CRM may store a service level agreement (SLA) that includes various preferences, compensation agreements, content restrictions, etc.

Accordingly, in one embodiment, there is a CRM server 108 that is coupled for communication via the network 106. In the example of FIG. 1, the CRM server 108 offers its account holders (e.g., subscribers to the content distribution service) on-line access to a variety of functions related to the account holders' account, such as on-line payment information, subscription changes, password control, etc., including restrictions with respect to what they are willing to display on their outward display device of the CDV.

Upon determining the appropriate content based on a predetermined prioritization and/or any restrictions for a particular CDV, the content distribution engine can send the appropriate content to a CDV upon the CDV entering a region. By virtue of sending only relevant content and only when entering a subject region, the amount of processing by the content distribution server and resources of the network 106 are conserved. Upon the CDV entering a zone, which is within the subject region, the CDV can display the content on the outward display device in a way that is synchronous to one or more CDVs in the zone or subzone. By virtue of synchronization with other outward display devices in a common zone, the effective dwell time for a moving audience can be substantially increased. In one embodiment, upon completion of the display of the content on its outward display device, a CDV sends a follow-up data packet indicating a length of time the content was displayed. In some embodiments, the data packet also includes the CDV status information, as discussed above. In this way, the owner of the CDV can be appropriately compensated by the content distribution server 102.

While the CRM server 108, content providers 112(1) to 112(N), and content distribution server 102 are illustrated by way of example to be on different platforms, it will be understood that in various embodiments, these platforms may be combined in various combinations. In other embodiments, these computing platforms may be implemented by virtual computing devices in the form of virtual machines or software containers that are hosted in the cloud 140, thereby providing an elastic architecture for processing and storage.

### Example Synchronized Content Delivery Zones

As mentioned previously, content to be communicated from one moving object to another may be specific to a zone. Zones may have different granularity depending on the purpose of the content and the resolution of the location identification tool. In this regard, various GPS and/or triangulation techniques can be used to determine a location of a CDV. Today, the resolution of GPS can be +/−3 meters but can be enhanced by additional known techniques. In some embodiments, multilateration and/or triangulation can be used. Cellular multilateration is a technique based on measuring the difference in distance in which two known cell towers' locations receive a signal from a mobile device at an unknown location. There are an endless number of potential locations based on distance measurements alone, but when the points are plotted together, they form a hyperbolic curve. To determine where the mobile device lies along the curve, measurements are taken again, but this time with a different set of cellular towers. The second hyperbolic curve produced should intercept the first curve at certain points, producing a small number of possible locations for the missing phone. Multilateration executed in urban areas, where cell towers are abundant, is more likely to produce a more precise result, whereas multilateration carried out in rural areas, where cell towers are miles away from each other, will result in a significantly less precise reading.

In one embodiment, cellular triangulation using cell towers can be used to determine a location and direction of a mobile device. However, instead of measuring distances, triangulation measures the angles to the lost device from the ends of a baseline (in this case, the two cell towers act as the “ends”, and the baseline is the line connecting the two cell towers). When the requisite angles are known, two lines from each tower can be drawn out at the specified angles until the lines cross, forming a triangle. The point at which the lines cross represents the approximate location of the subject mobile device.

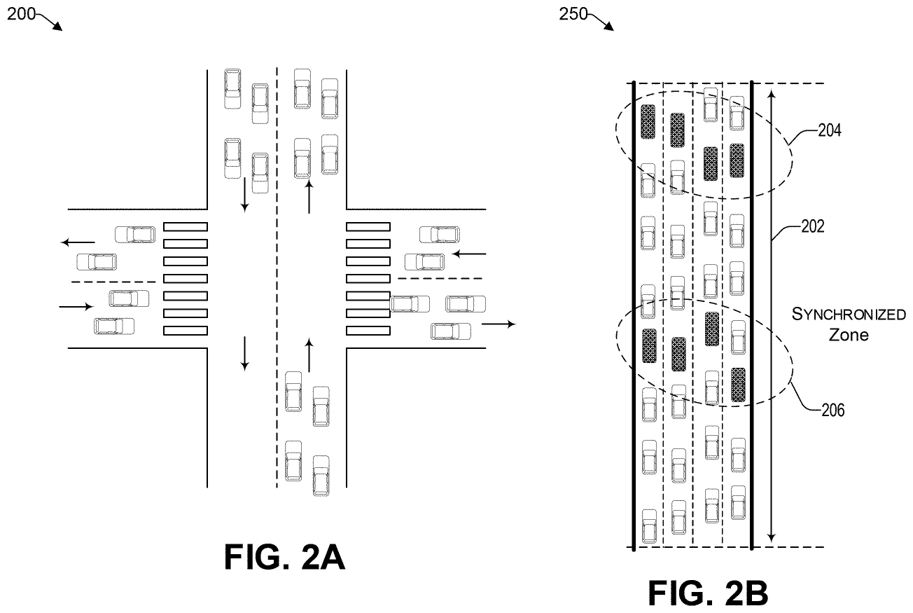

FIG. 2A illustrates an example intersection that may be a zone or subdivided into subzones. For example, in the zone 200, eastbound traffic may be a first subzone; western traffic may be a second subzone; northbound traffic may be a third subzone; and southbound traffic may be a fourth subzone. Each subzone can be distributed a different content, which is displayed by one or more outward display devices of corresponding CDVs.

Reference now is made to FIG. 2B, which illustrates one side of a highway 250 that includes a plurality of synchronized CDVs, consistent with an illustrative embodiment. For example, each direction of the highway may be treated as a separate zone. In each zone (e.g., 202), the content is synchronized displayed by the outward display of corresponding CDVs (represented by crosshatch vehicles) is synchronized. In some embodiments, where the zone 202 is longer or wider than a predetermined threshold, there may be multiple synchronized groups of CDVs. Stated differently, in some scenarios, a zone may include more than one group (e.g., group 204 and group 206) of synchronized CDVs displaying content.

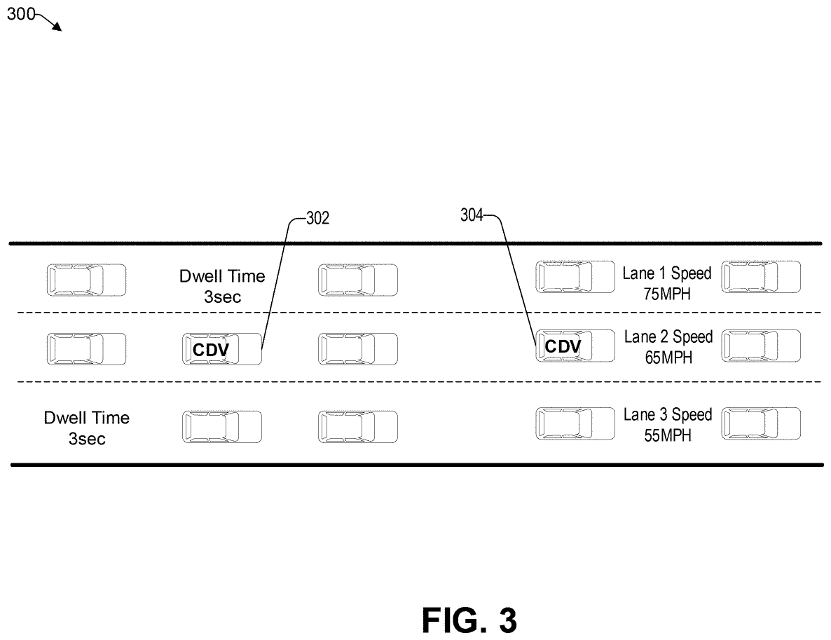

The concept of synchronization of content between separate moving vehicles may be better understood in view of FIG. 3, which provides one side of a highway 300 that includes a plurality of CDVs in a zone, consistent with an illustrative embodiment. As illustrated in FIG. 3, there are two available CDVs, namely 302 and 304 in a same zone and traveling in a same direction. By virtue of synchronizing a content between the outward display devices of the CDVs 302 and 304, the dwell time is substantially increased (e.g., from 3 seconds to 6 seconds). Stated differently, the content can be played back on both outward display devices of CDVs 302 and 304. In this way, vehicles that may be traveling faster or slower than the subject CDVs 302 and 304, will be exposed to a longer portion of the content.

In one embodiment, the absolute display times of the same content on the two CDVs may not be identical; rather, it is offset by the separation distance between the two CDVs along with their respective speeds. Hence, the viewing vehicles will see the same advertising content for twice as long.

In one embodiment, each CDV includes one or more sensors, (e.g., backward facing camera, laser distance sensors, and/or radar) that are operative to determine the relative speeds of the target audience vehicles around them. This information may be sent to the content distribution engine to calculate a number of CDVs to involve in each lane to achieve a desired dwell time in a zone.

The content is distributed by the content distribution engine and displayed on outward display devices of CDVs based on a duration based governed by the campaign requirements provided by the content provider(s) and ranking of the content, as discussed in more detail later.

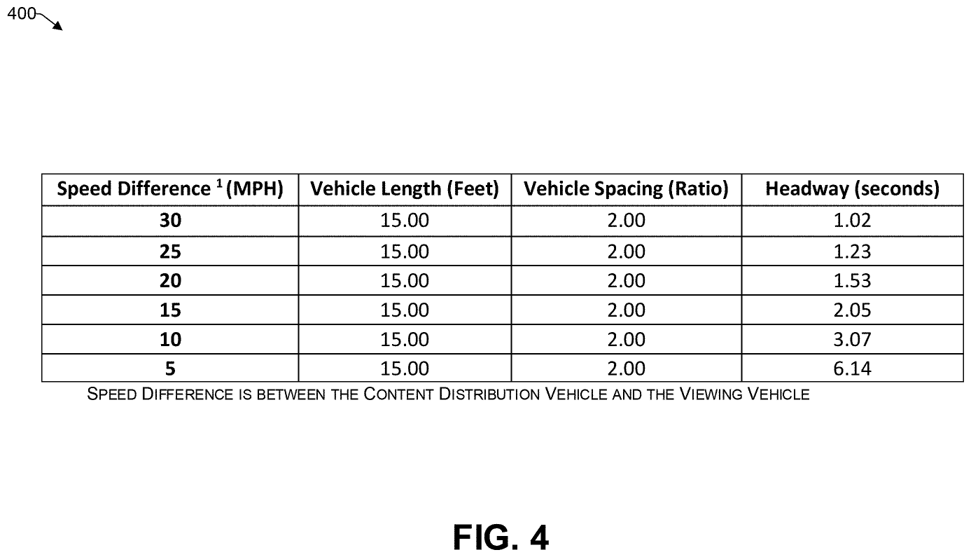

The dwell time of the viewership is dependent upon a combination of the traffic flow and the content's display duration. In this regard, FIG. 4 is a table 400 that provides a comparison of different traffic flow rates, consistent with an illustrative embodiment. More specifically, table 400 provides a speed difference between a CDV and its corresponding viewing vehicle (e.g., audience) and their associated headways (time spent crossing).

Accordingly, in relative fast traffic conditions, the viewer spends a shorter time crossing the CDV whereas in slow traffic conditions, the viewer spends a longer time crossing the CDV. This time overlap directly correlates to dwell time, albeit the relationship is based on the difference in speeds (CDV vs. viewing vehicle). The teachings herein take into consideration such traffic flow and content campaign parameters and leverage the availability of multiple subscribed CDVs and their geographic location proximity to determine the multiplicity requirements based on the requisite dwell time. The system then synchronizes the displays in these determined number of CDVs allowing playback of the same advertising content, thereby increasing the dwell time of passing audience vehicles.

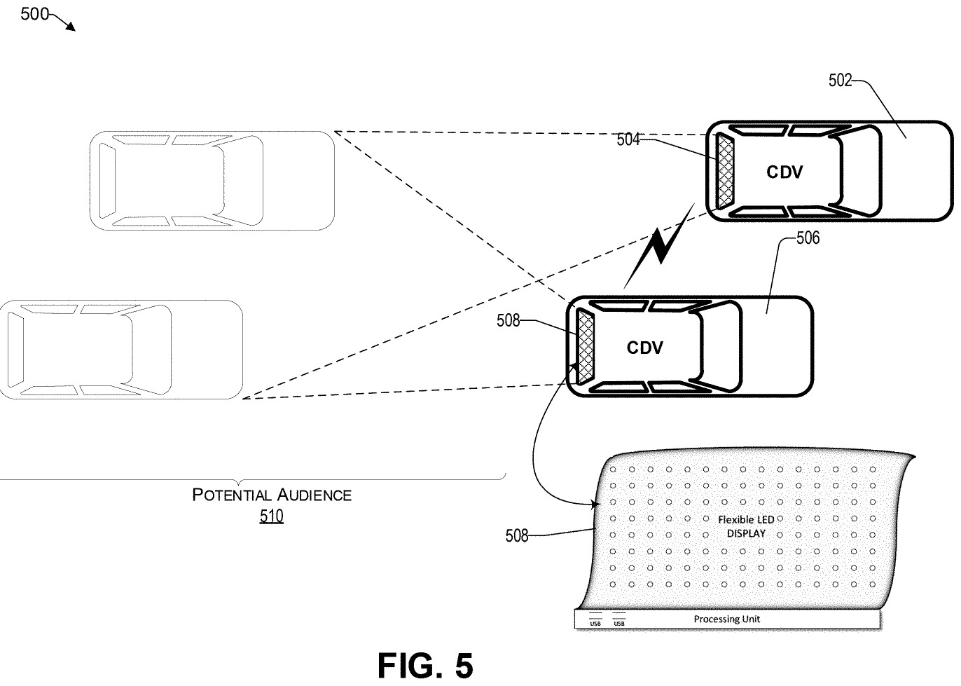

FIG. 5 illustrates a system 500 of two CDVs having flexible outward display devices that are synchronized to each other. For example, CDVs 502 and 506 each have an outward display device in a form of a flexible LED display attached to a rear windshield. The potential audience includes any vehicles that are within a viewing distance of the synchronized flexible displays 504 and 508. In one embodiment, a mobile device carried in the CDV 508 (e.g., a user of the CDV 506 communicates processing unit 510 of the outward display device 508 to provide the content it has received from the content distribution engine. In other embodiments, the processing unit 510 is independent in that it has its own processing components, such as GPS, display drivers, storage media, synchronization logic, and cellular based communication capabilities, without requiring the mobile device carried in the CDV to be used as a bridge to fulfill these functions.

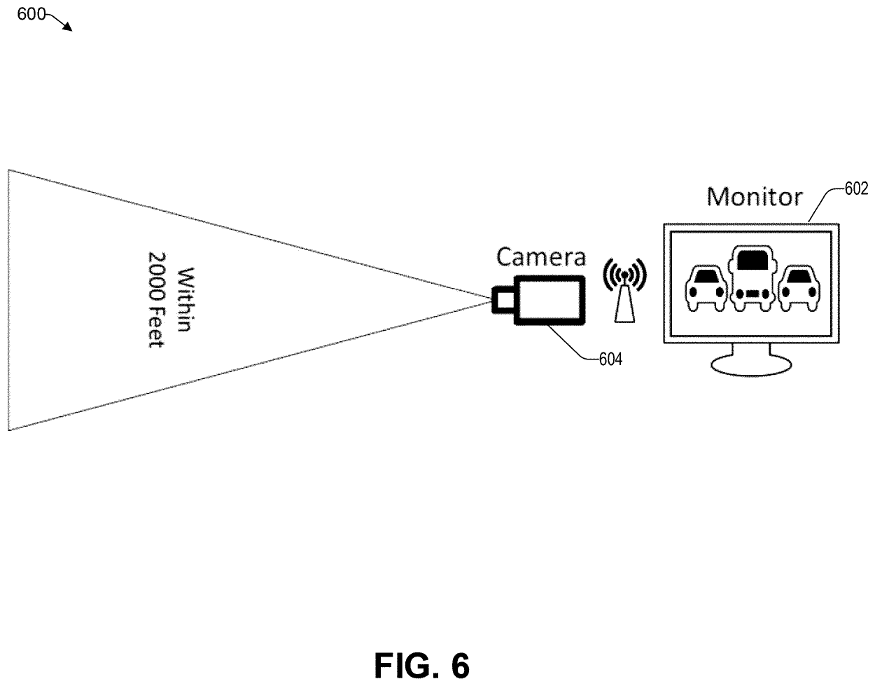

FIG. 6 provides an example camera 604 and a monitor 602, consistent with an illustrative embodiment. In system 600, the camera 604 may be used to display the traffic to a driver of the CDV. In this way, the back window of the CDV can be retrofitted with an outward display device without obstructing the backward traffic information from the driver of the CDV. An unobstructed image behind the CDV for up to 200 feet, despite the flexible display being attached to the rear windshield. In one embodiment, the camera 604 is integrated in the outward display device. In some embodiments, the outward display device can be readily removed and/or turned OFF by the user of the CDV.

### Example Considerations for Out of Home Content Delivery

In one aspect, there is a hierarchy for Out of Home (OOH) content delivery on CDVs. The strategy is dynamic where market conditions, such as content display time/frequency/duration, signage availability and display time slot supply/demand, dictate prices. In one aspect, the present teachings include a fair queuing on dynamic pricing where content is placed in queues based on content display requirements. For example, each queue is a different ad content display category and has its own assigned signage display time. In other words, each queue is guaranteed a percentage of the total display time and media content in any queue is not dropped irrespective of their price points.

Based on a content provider's content display requirements, the content is placed in the most relevant queue. A price target may be provided to the content provider by the content distribution engine automatically, as a quote. The queues themselves may be dynamic. The queues can be regenerated periodically to update media content. The actual price to display the media content can be based on market conditions and is updated periodically as well. The content provider can choose to maintain the current queue position with its pricing or change the queue category as desired. This change, if implemented, is instantaneous—generating a new position assignment in a new queue.

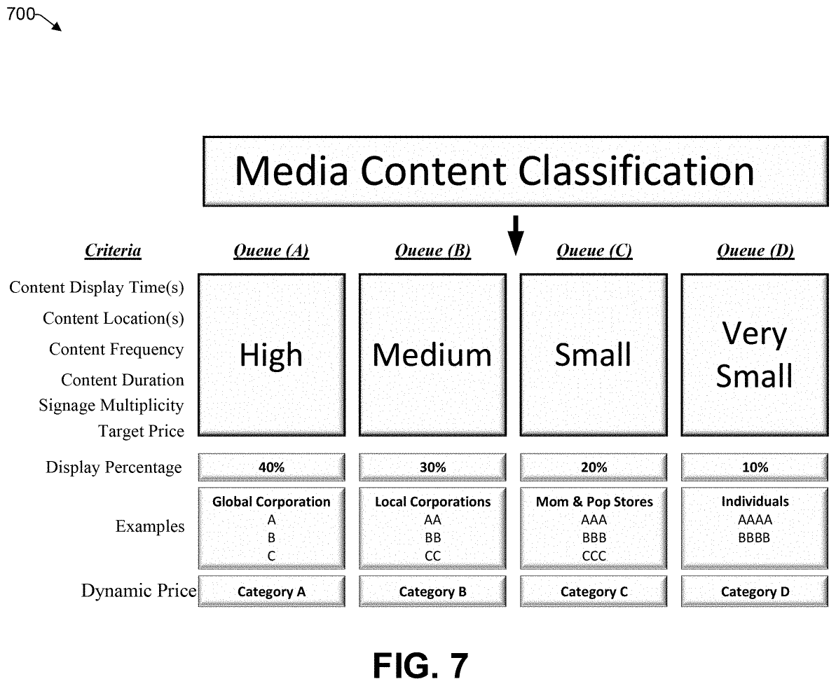

FIG. 7 shows example dynamic media content classification 700 having a fair queuing system consistent with an illustrative embodiment. Each content may be initially classified using several criteria (e.g., display time, location, frequency, duration, multiplicity, etc.,) and placed in one of several queues, and a target price is determined. Each queue category has a predetermined display time percentage. In one embodiment, the display time percentage can change based on queue contents (e.g., media content such as safety/benefit messages, public safety, or advertisements). If a queue is empty, its display allocation time can be distributed to other queues.

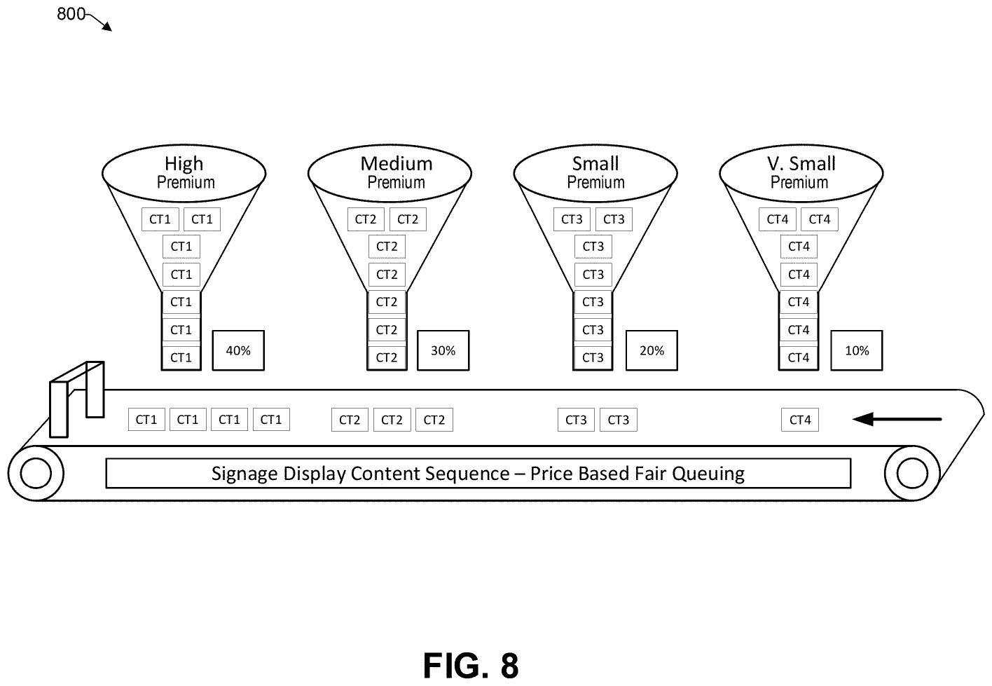

FIG. 8 an example content sequencing for a display having a price point based queuing, consistent with an illustrative embodiment. A content provider can choose to accept the queue category or change the queue if desired. The queue's price point is periodically updated based on real time market conditions (viewership). If a queue gets larger than its allocated display time, some of its content is redistributed to lower price point queues reflecting the adjusted price. Once the queue becomes available, its redistributed ad content is brought back. Allocating a specific display time percentage to each queue ensures all content has a guaranteed display time prospect.

### Example Processes:

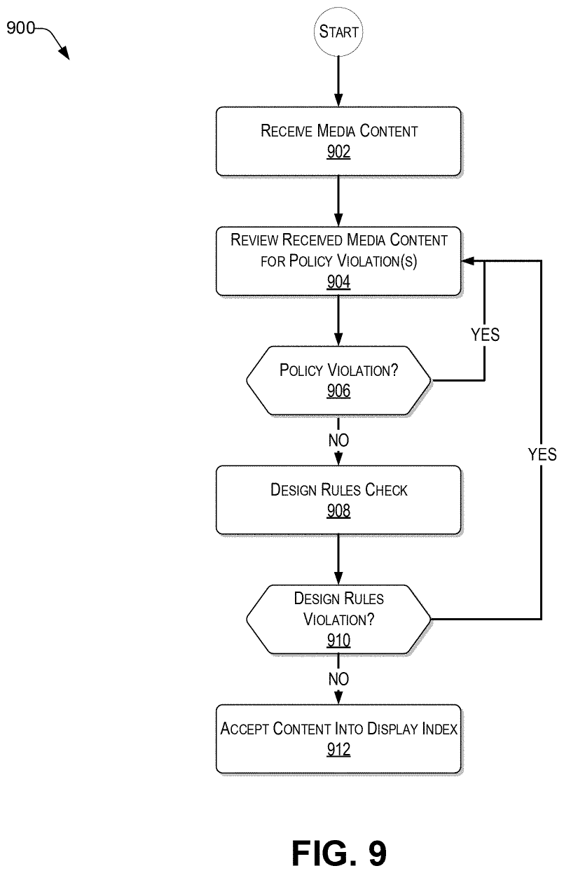

With the foregoing overview of the example architecture 100 and explanation of granularity of zones, it may be helpful now to consider a high-level discussion of example processes. To that end, FIGS. 9 to 17 present illustrative processes of different aspects of distributing media content to CDVs, consistent with example embodiments.

Processes 900 to 1700 are illustrated as a collection of blocks in logical flowcharts, which each represent a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform functions or implement abstract data types. The order in which the operations are described is not intended to be construed as a limitation, and any number of the described blocks can be combined in any order and/or performed in parallel to implement the process. For discussion purposes, the processes 900 to 1700 are described with reference to the architecture 100 of FIG. 1.

Referring back to FIG. 1, as discussed above, the content distribution engine 102 facilitates content providers 112(1) to 112(N) to distribute content 114(1) to 114(N), such as public service announcements, event information, and ads to be displayed on vehicles at a predetermined time of the day at a predetermined zone on an outward display device that may be mounted on rear windshield of a vehicle. Content providers 112(1) can access the content distribution engine via a network 106, which enables them to submit the content 114(1) to 114(N) (e.g., which may be public service announcements or ads) in text, graphical, and/or audio format.

FIG. 9 illustrates a process 900 for a computer implemented automatic media content entry, consistent with an illustrative embodiment. At block 902, media content is received by the content distribution engine 104. Along with the content, the data packet (e.g., 114(1)) may include additional parameters, such as where the content is to be displayed, at what time the content should be displayed, the frequency of display, if multiple vehicles display the content then if there are any physical separation requirements between display of content in order to optimize content distribution campaign, sometimes referred to herein as the ad spend, and other such parameters.

At block 904 the media content is reviewed for internal (e.g., content distribution engine 104) policy violations. For example, the received content is scanned by an automated system to ensure that the content meets content policy. Internal content policy may include, but is not limited to, sexually explicit advertising, political messages, insensitive content, etc. In one embodiment, the content distribution engine 104 can return a data packet that includes one or more warnings for the content provide based on font size requirements, colors used, whether the subject matter is compatible, etc.

At block 906, upon determining that an internal content policy violation is detected (i.e., “YES” at determination block 906), it is flagged to the content provider (e.g., 112(A)) and not included in the pool of media content to be distributed to appropriate subscribed CDVs. However, if an internal content policy violation is not detected (“NO” at determination block 906), the process continues with block 908 discussed below.

For example, since the CDVs that display the media content may be private vehicles who have subscribed to the present content delivery service, there can be instances when owners/drivers of the CDVs are not comfortable with certain content (e.g., religious ads, political ads, etc.). In this regard, at block 908 the content distribution engine 104 determines whether there is a design rule violation (e.g., a limitation related to an account of the CDV). For example, the content distribution engine 104 allows account holders to set policies on content based on categories and/or keywords. In various embodiments, these limitations can be provided in the data packet 114(1) and/or stored in the CRM 108, which can be received by the content distribution engine 104. In one embodiment, the present architecture also allows drivers to turn off outward display device entirely.

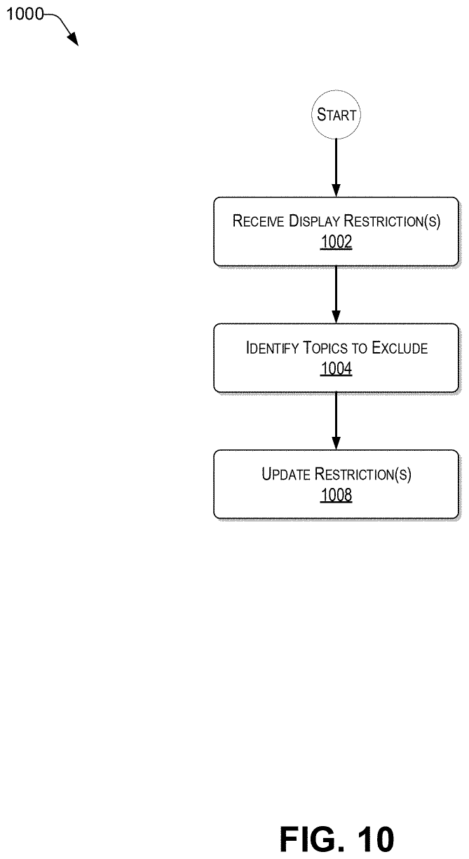

When certain categories of content are marked to not be displayed in connection with an account of a CDV (i.e., “YES” at determination block 920), the content distribution engine 104 removes the subject content from the display queue for the CDV. In one embodiment, the processing of the content distribution engine 104 is simplified and the determination is made by the processor of the CDV. In some embodiments, CDVs in a zone receive the content from the content distribution engine and negotiate synchronization between these CDVs based on their dynamic location and speed. The CDV may update the CRM 108 and/or the content distribution server 102 regarding acceptable content by sending a rejection notification to the content distribution engine 104. In this way, a more appropriately tailored content may be distributed by the content distribution engine 104 in future iterations for this CDV. In this regard, reference is made to FIG. 10, which illustrates a simplified interaction 1000 between a computing device of the CDV and the content distribution engine 104 in response to content received by the CDV. At block 1002, one or more display restrictions are received by the content distribution engine 104. In various embodiments, these restrictions may be received directly from the computing device of the CDV or the CRM 108. At block 1004, the topics to exclude are identified by the content distribution engine 104. At block 1008, the display restrictions are automatically updated in a memory of the content distribution server 102.

Returning to FIG. 9, at block 912, upon accepting the content received form the content distribution engine 104, the CDV can display the content upon entering a zone in a way that is synchronous to other CDVs in the same zone displaying the same content.

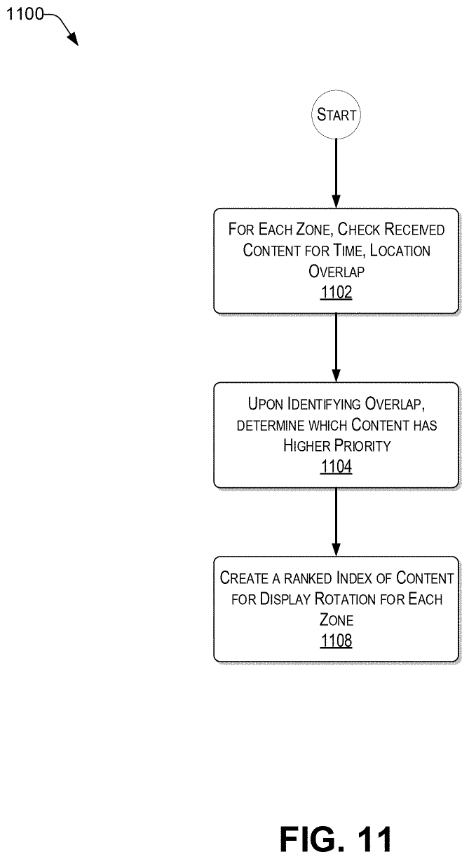

In one embodiment, multiple content media may be submitted to be displayed having the same display requirements (location/time). In such scenario, the content provider (e.g., 112(A)) has the opportunity to achieve higher priority for distributing its content 114(1) (e.g., by paying a higher fee). In this regard, reference is made to FIG. 11, which illustrates an example process 1100 for handling conflicting requests from content providers, consistent with an example embodiment. At block 1102, for each zone, the content distribution engine 104 checks the received content for a time and location overlap.

At block 1104, upon identifying an overlap, the content distribution engine 104 determines which content has a higher priority. For example, public service announcements related to traffic, safety, weather, or police, may have higher priority than welcoming messages or advertisement content.

At block 1108, the content distribution engine 104 creates a ranked index of content for a display rotation for each zone. In one embodiment, the content distribution engine 104 enables anonymous, automatic auction in case there is resource constraint for display of content.

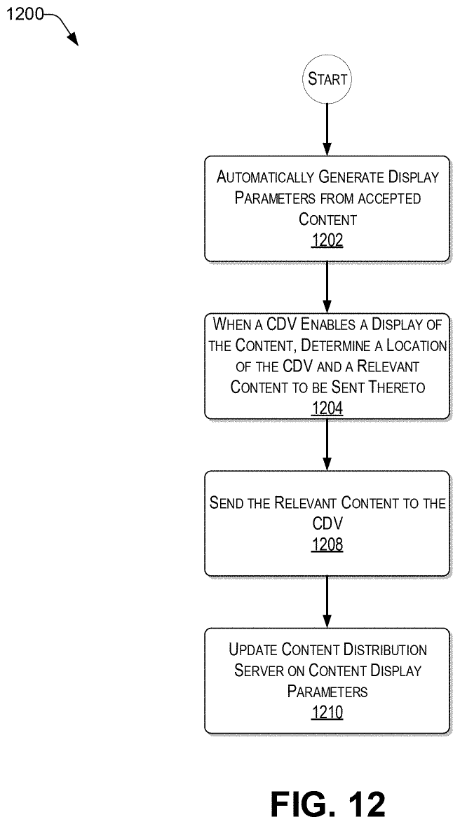

Reference now is made to FIG. 12, which provides an example process 1200 for an automatic distribution of media content, consistent with an illustrative embodiment. At block 1202, the content distribution engine 124 automatically generates display parameters from accepted content. For example, display parameters can be factors that influence displaying an advertisment at a zone/time. A content provider may place a media content to be displayed in a particular neighborhood (e.g., zone), or at a particular time/day, or any combinatiion thereof. In one embodiment, the parameters could also be based on a trigger event. For example, free reward that can be picked up at a location if a local team wins the National Baseketball Association (NBA) championship, immediately after the local team wins, for the next 1 day. Display parameters can also include meta data such as the category of the media content, which queue it belongs to, and so on.

At block 1204, when a CDV enables a display of the received content, the content distribution engine 124 can learn of the status of the CDV by receiving a notification therefrom. In various embodiments, this notification may be immediate (as soon as the CDV is enabled) and/or upon predetermined intervals that may be initiated by the content distribution engine 104. The same may occur when the CDV is disabled. In this way, the content distribution engine 104 determines the location of the CDV and can determine the relevant content to be sent thereto.

At block 1208, the content distribution engine 104 sends the relevant content to the CDV.

At block 1210, the content distribution engine 104 updates the content display parameters. When a content is displayed, the content distribution engine 104 stores the time, duration, and zone of display. This information can be used for billing purposes of the content provider (e.g., 112(A)) and for compensating an account of the subject CDV(s) that have displayed the content on their outward display device(s).

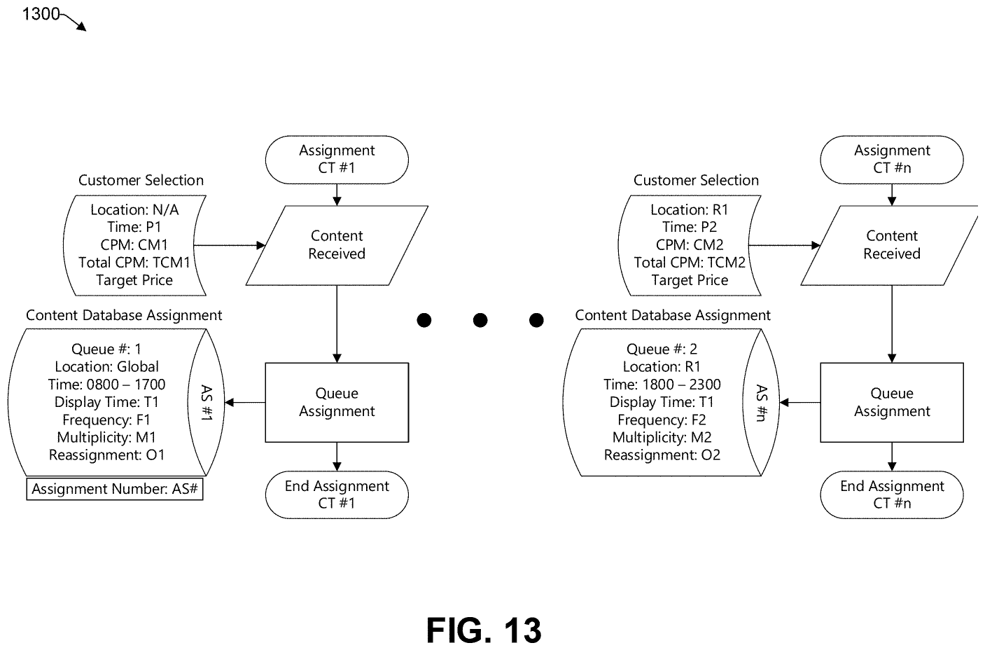

FIG. 13 shows an example queue assignment sequence 1300, consistent with an illustrative embodiment. Once a media content is received, based on the content provider's selected one or more criteria, a database instance (header) for the content is created by the content distribution engine 104 that describes its assigned queue with all its associated parameters (e.g., subset of the list shown in FIG. 13). In one embodiment, the content provider can provide the content, selection, and/or preferences via a Web portal.

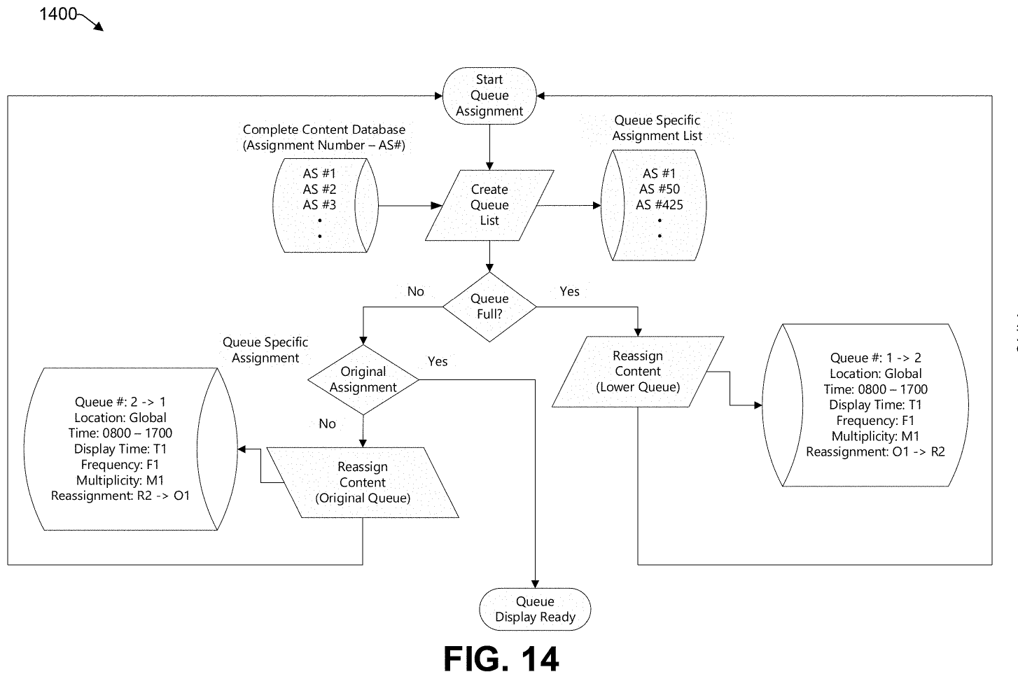

FIG. 14 shows an example queue building sequence 1400, consistent with an illustrative embodiment. Periodically, each queue's media contents are updated from a content database, such as a content provider, to reflect the queue's display. Reassignment of media contents to a different queue is shown if the queue exhausts its assigned display time.

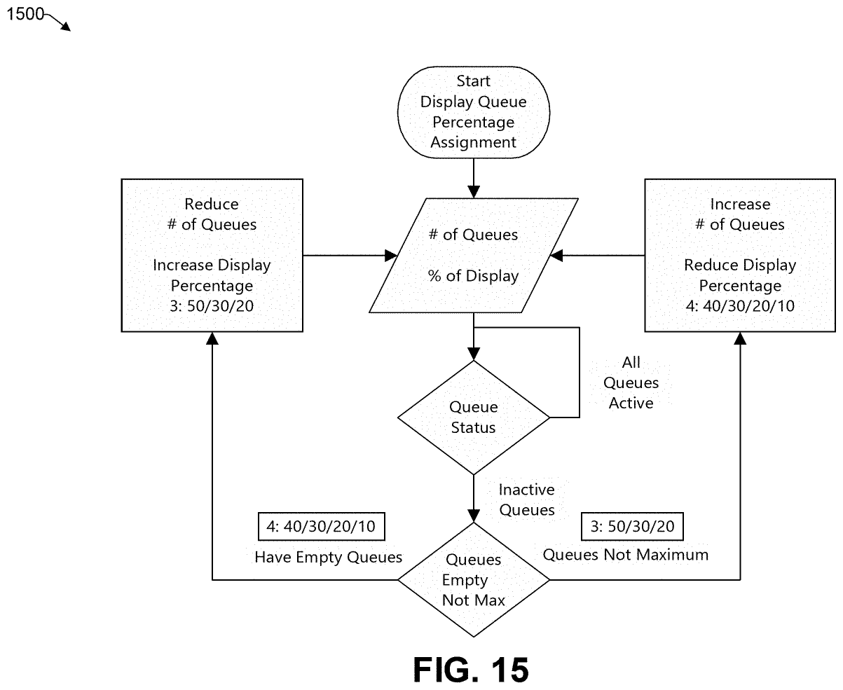

FIG. 15 shows an example display percentage adjustment for each queue 1500, consistent with an illustrative embodiment. For example, if a queue is empty, its assigned percentage is brought down to 0 and the display percentage of other queues is adjusted accordingly.

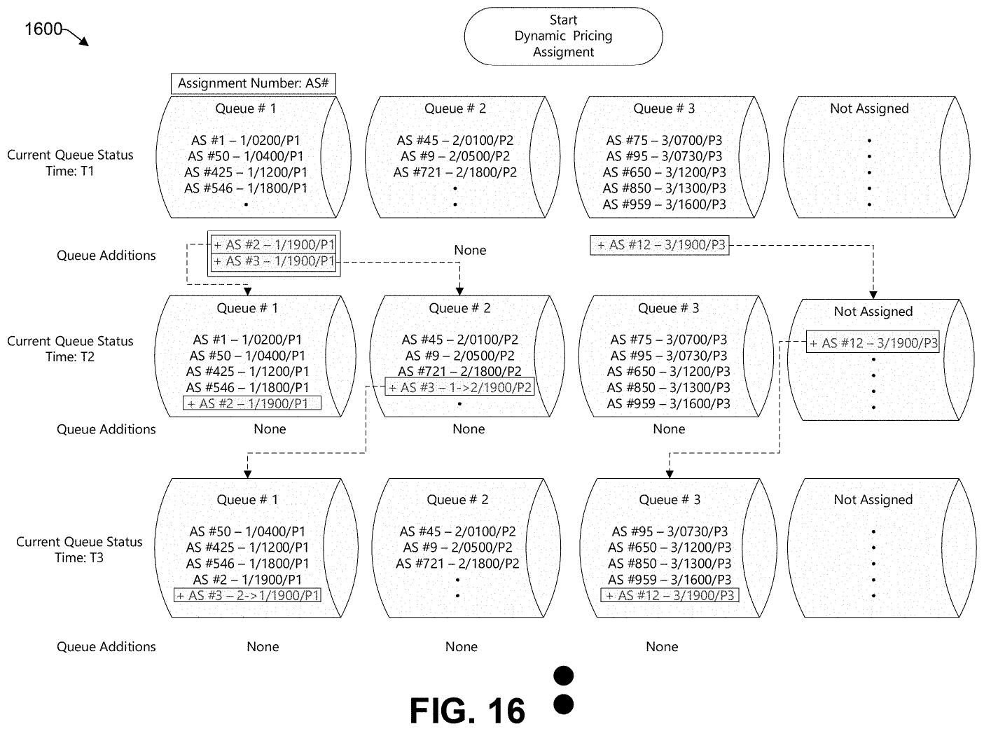

FIG. 16 shows an example of dynamic value of media content determination 1600, consistent with an illustrative embodiment. By way of example only and not by way of limitation, four queues are shown, namely Queue #1, Queue #2, Queue #3, and Not Assigned Queue. Each queue has a list of assigned media content (e.g., shown with their header database instance—AS #). As an example, at Time T1, ads AS #1, AS #20, AS #425 and AS #546 are assigned to Queue #1. In the example of FIG. 16, each queue has a capacity of five media contents.

As can be seen, at T1, Queue #1 has 4 media contents, Queue #2 has 3 media contents, and Queue #3 has 5 media contents. Also shown at T1 are three media contents, namely AS #2, AS #3 and AS #12, which need queues assignments. AS #2 get assigned to Queue #1 since there is availability. However, AS #3 cannot be assigned since Queue #1 gets full once AS #2 is added. To accommodate AS #3, it is assigned to Queue #2 as there is availability albeit with a new P2 price point (instead of P1). In one embodiment, the content provider is informed of this change.

AS #12 is pushed into the “Not Assigned” queue since Queue #3 is already full and there are no lower priced queues available. However, in this case, the content provider is messaged with a request for their willingness to accept a different (i.e., higher—Queue #2 has availability) price point to display their media content. T2 shows the queue status.

In one embodiment, it is possible that AS #12 is assigned to Queue #2—since there is availability. This assignment does not change the original price point and is at the content distribution engine's discretion.

At T3, Queue #1 has availability (AS #1 expires) and AS #3 is reassigned with a content provider notification. Similarly, AS #12 gets assigned to Queue #3 (AS #75 expires) again due to availability.

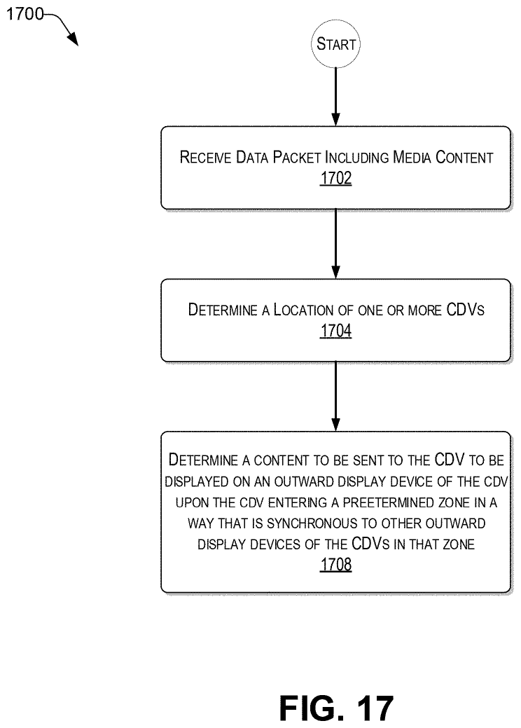

Reference now is made to FIG. 17, which provides a simplified process flow 1700 for distributing relevant media content to CDVs in a zone, consistent with an illustrative embodiment. At block 1702, the content distribution engine 104 receives a data packet (e.g., 114(1)) including media content from one or more content providers 112(A) to 112(N). In addition to the media content, the data packet (e.g., 114(1)) may include a zone, a time of day, and a desired frequency of distribution of the media content.

At block 1704, a location (and direction) of one or more CDV. In various embodiments, the determination of the location is at predetermined intervals or upon a trigger event, such as a CDV entering a region or zone, and/or the display aspect discussed herein being activated in a CDV. In some embodiments, the determination of the location of the one or more CDVs includes receiving, from each corresponding CDV, any restrictions for media content.

At block 1708, for each CDV, the content distribution engine determines a content to be sent to the CDV, to be displayed on an outward display device of the CDV upon the CDV entering a predetermined zone. Significantly, the display on an outward display is synchronous to other outward display devices of CDVs in that zone. In various embodiments, the determination of a content to be sent comprises determining whether the content violates any internal criteria of the content distribution engine and/or determining whether the content violates any limitation related to an account of the CDV. Any content that violates any internal criteria or any limitation related to the account of the CDV is removed from a queue for display in the subject zone. All remaining content received from the one or more content providers 112(A) for that zone is ranked based on one or more predetermined criteria. The media content is then sent by the content distribution engine 104 to the CDV upon it entering a region that includes the zone. The actual synchronized display is upon the CDV entering the subject zone.

### Example Computer Platform

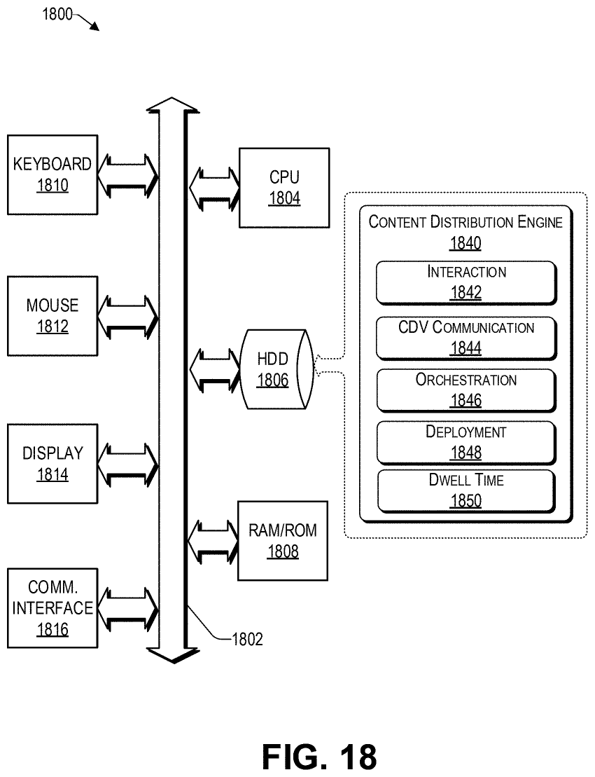

As discussed above, functions relating to provisioning a media content to one or more content delivery vehicles can be performed with the use of one or more computing devices connected for data communication via wireless or wired communication, as shown in FIG. 1 and in accordance with the processes 900 to 1700. FIG. 18 is a functional block diagram illustration of a computer hardware platform that can communicate with various networked components, such as other computing devices of CDVs, CRM server 108, content providers 112(A), the cloud 140, and other devices coupled to the network 106. In particular, FIG. 18 illustrates a network or host computer platform 1800, as may be used to implement a server, such as the content distribution server 102 of FIG. 1.

The computer platform 1800 may include a central processing unit (CPU) 1804, a hard disk drive (HDD) 1806, random access memory (RAM) and/or read only memory (ROM) 1808, a keyboard 1810, a mouse 1812, a display 1814, and a communication interface 1816, which are connected to a system bus 1802.

In one embodiment, the HDD 1806, has capabilities that include storing a program that can execute various processes, such as the content distribution engine 1840, in a manner described herein. The content distribution engine 1840 may have various modules configured to perform different functions. For example, there may be an interaction module 1842 that is operative to communicate with various content providers to receive media content therefrom, as discussed herein. There may be a CDV communication module 1844 operative to receive status information from various CDVs in disparate regions as well as provide tailored media content that is synchronized with other CDVs in a subject zone. There may be an orchestration engine 1846 operative to prioritize media content for each zone based on various criteria and limitations discussed herein. There may be a deployment module 148 operative to deploy (e.g., distribute) the relevant media content to one or more CDVs at appropriate times. There may be a dwell time module operative to receive feedback from the CDVs to calculate a dwell time for each media content.

### CONCLUSION

The descriptions of the various embodiments of the present teachings have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

The components, steps, features, objects, benefits and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

Aspects of the present disclosure are described herein with reference to a flowchart illustration and/or block diagram of a method, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures herein illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A computing device comprising:
a processor;
a network interface coupled to the processor to enable communication over a network;
a storage device coupled to the processor;
a content distribution engine stored in the storage device, wherein an execution of the engine by the processor configures the computing device to perform acts comprising:
receiving a data packet including media content from one or more content providers;
determining a location of one or more content delivery vehicles (CDVs); and
for each CDV of the one or more CDVs:
selecting a content to be sent to the CDV; and
sending the selected content to the CDV to be displayed on an outward display device of the CDV upon the CDV entering a predetermined zone, in a way that is synchronous to other outward display devices of the CDVs in the predetermined zone.

2. The computing device of claim 1, wherein the data packet includes a zone, a time of day, and a frequency of distribution of the media content.

3. The computing device of claim 1, wherein the one or more content providers comprise a police department, a fire department, or a municipality.

4. The computing device of claim 1, wherein a content provider of the one or more content providers is an advertiser.

5. The computing device of claim 1, wherein execution of the content distribution engine further configures the computing device to perform an additional act comprising determining a direction of travel of the one or more CDVs.

6. The computing device of claim 1, wherein the determination of the location of the one or more CDVs comprises, for each CDV, receiving a data packet from the CDV at predetermined intervals or upon a trigger event.

7. The computing device of claim 6, wherein the data packet from the CDV includes one or more restrictions on what can be displayed on an outward display device of the CDV.

8. The computing device of claim 1, wherein execution of the content distribution engine further configures the computing device to perform an additional act comprising receiving from a server one or more restrictions on what can be displayed on the CDV.

9. The computing device of claim 1, wherein the determination of a content to be sent to the CDV comprises:
determining whether the content violates any internal criteria of the content distribution engine;
determining whether the content violates any limitation related to an account of the CDV; and
removing any content that violates any internal criteria or any limitation related to the account of the CDV.

10. The computing device of claim 9, wherein the determination of a content to be sent to the CDV further comprises:
ranking all remaining content received from the one or more content providers based on one or more predetermined criteria; and
sending a content that has a highest rating to the CDV upon the CDV entering a region that includes the zone.

11. A non-transitory computer readable storage medium tangibly embodying a computer readable program code having computer readable instructions that, when executed, causes a computer device to carry out a method of distributing media content, the method comprising:
receiving a data packet including media content from one or more content providers;
determining a location of one or more content delivery vehicles (CDVs); and
for each CDV of the one or more CDVs:
selecting a content to be sent to the CDV; and
sending the selected content to the CDV to be displayed on an outward display device of the CDV upon the CDV entering a predetermined zone, in a way that is synchronous to other outward display devices of the CDVs in the predetermined zone.

12. The non-transitory computer readable storage medium of claim 11, wherein the data packet includes a zone, a time of day, and a frequency of distribution of the media content.

13. The non-transitory computer readable storage medium of claim 11, further comprising determining a direction of travel of the one or more CDVs.

14. The non-transitory computer readable storage medium of claim 11, wherein:
the determination of the location of the one or more CDVs comprises, for each CDV, receiving a data packet from the CDV at predetermined intervals or upon a trigger event; and
the data packet from the CDV includes one or more restrictions on what can be displayed on an outward display device of the CDV.

15. The non-transitory computer readable storage medium of claim 11, wherein the determination of a content to be sent to the CDV comprises:
determining whether the content violates any internal criteria of the content distribution engine;
determining whether the content violates any limitation related to an account of the CDV; and
removing any content that violates any internal criteria or any limitation related to the account of the CDV.

16. The non-transitory computer readable storage medium of claim 15, wherein the determination of a content to be sent to the CDV further comprises:
ranking all remaining content received from the one or more content providers based on one or more predetermined criteria; and
sending a content that has a highest rating to the CDV upon the CDV entering a region that includes the zone.

17. A computer implemented method comprising:
receiving a data packet including media content from one or more content providers;
determining a location of one or more content delivery vehicles (CDVs); and
for each CDV of the one or more CDVs:
selecting a content to be sent to the CDV; and
sending the content to the CDV to be displayed on an outward display device of the CDV upon the CDV entering a predetermined zone, in a way that is synchronous to other outward display devices of the CDVs in the predetermined zone.

18. The method of claim 17, wherein the data packet includes a zone, a time of day, and a frequency of distribution of the media content.

19. The method of claim 17, further comprising determining a direction of travel of the one or more CDVs.

20. The method of claim 17, wherein:
the determination of the location of the one or more CDVs comprises, for each CDV, receiving a data packet from the CDV at predetermined intervals or upon a trigger event; and
the data packet from the CDV includes one or more restrictions on what can be displayed on an outward display device of the CDV.
